(19) United States
(12) Patent Application Publication
(10) Pub. No.: US 2024/0202642 A1
(43) Pub. Date: Jun. 20, 2024

(54) PROCESSING METHOD, PROCESSING DEVICE, AND PROCESSING PROGRAM

(71) Applicant: NIPPON TELEGRAPH AND TELEPHONE CORPORATION, Tokyo (JP)

(72) Inventors: Yoshifumi FUKUMOTO, Tokyo (JP); Takashi FUJINAMI, Tokyo (JP); Hiroharu TOYODA, Tokyo (JP); Yusuke KIRA, Tokyo (JP)

(73) Assignee: NIPPON TELEGRAPH AND TELEPHONE CORPORATION, Tokyo (JP)

(21) Appl. No.: 18/554,156

(22) PCT Filed: Apr. 9, 2021
(86) PCT No.: PCT/JP2021/015100

§ 371 Date: Oct. 5, 2023

(51) Int. Cl. G06Q 10/0639

(52) U.S. Cl. CPC G06Q 10/06398

(57) ABSTRACT

A processing device (10) includes: a collection unit (131) that collects operation logs of terminals used by a plurality of staffs who perform work; a proficiency element extraction unit (132) that extracts a feature amount for each staff from the operation log collected by the collection unit (131); and a proficiency level calculation unit (134) that calculates a proficiency level of work for each staff from the feature amount extracted for each staff by the proficiency element extraction unit (132). The proficiency level calculation unit (134) calculates the proficiency level by performing weighting that increases as the time required for work increases or weighting that increases as an error rate increases on the basis of work performed by the staff when the operation log is collected.

### TECHNICAL FIELD

The present invention relates to a processing method, a processing device, and a processing program.

### BACKGROUND ART

Work is often visualized for the purpose of efficiency and automation. For example, in a technology described in Non Patent Literature 1, visualization is performed by introducing a viewpoint of transaction in order to classify work.

### CITATION LIST

### Non Patent Literature

Non Patent Literature 1: Chihiro Suematsu, Shintaro Sengoku, and Yasuo Matsubara, “Gyoumuno kashika (toranzakushon sokutei bunseki) niyoru benchakeieishienno jisshoukenkyuu (Demonstrative research on support for venture management by work visualization (transaction measurement/analysis))”, Japan Society for Management Information, 2008 National Research Conference in November 2008 B2-5., [online], [retrieved on Mar. 16, 2021], Internet <URL:https://www.jstage.jst.go.jp/article/jasmin/2008f/0/2008f_0_38/_pdf/-char/en>

### SUMMARY OF INVENTION

### Technical Problem

As described in Non Patent Literature 1, since there are very few cases where work is completely the same for organizations or for individuals, it is difficult to uniquely evaluate the work, and evaluation is often performed for the entire organization or group (hereinafter described as “organization”).

However, in the evaluation as an organization, although it is possible to achieve optimization of the workload of the entire organization typified by review of the work flow and the like, the total sum of productivity accumulated for each staff belonging to the organization cannot be improved.

The present invention has been made in view of the above, and an object thereof is to provide a processing method, a processing device, and a processing program capable of calculating a proficiency level for each staff belonging to an organization.

### Solution to Problem

In order to solve the above-described problem and achieve the object, a processing method according to the present invention includes: a step of collecting operation logs of terminals used by a plurality of staffs who perform work; a step of extracting a feature amount for each staff from the collected operation log; and a step of calculating a proficiency level of work for each staff from the feature amount extracted for each staff. In the calculating step, the proficiency level is calculated by performing weighting that increases as time required for work increases or weighting that increases as an error rate increases on the basis of work performed by the staff when the operation log is collected.

### Advantageous Effects of Invention

According to the present invention, a proficiency level can be calculated for each staff belonging to an organization.

### BRIEF DESCRIPTION OF DRAWINGS

FIG. 1 is a diagram illustrating an outline of processing in an embodiment.

FIG. 2 is a diagram schematically illustrating an example of a configuration of a processing device according to the embodiment.

FIG. 3 is a diagram illustrating an example of a desktop screen of Windows.

FIG. 4 is a diagram illustrating a user interface (UI) tree.

FIG. 5 is a diagram illustrating operation logs collected by a collection unit illustrated in FIG. 2 and collection purposes thereof.

FIG. 6 is a diagram for describing a function of an operation data collection agent.

FIG. 7 is a diagram illustrating a list of proficiency elements extracted from an operation log.

FIG. 8 is a diagram for describing aggregation patterns of proficiency elements.

FIG. 9 is a diagram in which staff and work executed by each staff are associated with each other.

FIG. 10 is a diagram illustrating required time or error rate data when staffs perform work.

FIG. 11 is a diagram illustrating a calculation formula of a work difficulty level coefficient.

FIG. 12 is a diagram illustrating a table in which a work experience period, service years, a return rate, and a correlation coefficient with proficiency elements are associated with each other.

FIG. 13 is a diagram illustrating a table in which a work experience period, service years, a return rate, and a correlation coefficient with proficiency elements are associated with each other.

FIG. 14 is a diagram in which values of proficiency elements are associated with a work experience period of a team.

FIG. 15 is a diagram in which values of proficiency elements are associated with a work experience period of a team.

FIG. 16 is a diagram in which values of proficiency elements are associated with years of work experience.

FIG. 17 is a diagram in which values of proficiency elements are associated with years of work experience.

FIG. 18 is a diagram in which values of proficiency elements are associated with a return rate.

FIG. 19 is a diagram illustrating a correlation coefficient between the index and the proficiency element aggregated in Aggregation pattern 1.

FIG. 20 is a diagram illustrating a correlation coefficient between the index and the proficiency element aggregated in Aggregation pattern 2.

FIG. 21 is a flowchart illustrating a processing procedure of a processing method according to the embodiment.

FIG. 22 is a diagram illustrating an outline of the processing method according to the embodiment.

FIG. 23 is a diagram illustrating an example of a computer in which a program is executed to implement the processing device.

### DESCRIPTION OF EMBODIMENTS

Hereinafter, an embodiment of the present invention will be described in detail with reference to the drawings. Note that the present invention is not limited to this embodiment. Moreover, in the description of the drawings, the same parts are denoted by the same reference numerals.

### Embodiment

In the present embodiment, a technology for calculating a proficiency level of each staff on the basis of operation logs of terminals used by a plurality of staffs belonging to an organization will be described.

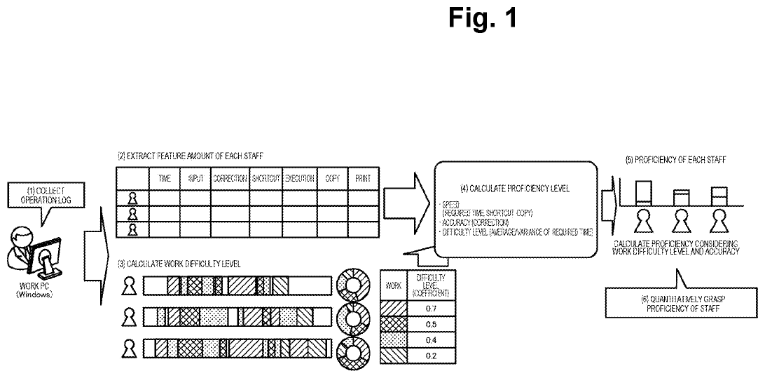

FIG. 1 is a diagram illustrating an outline of processing in the embodiment. As illustrated in FIG. 1, first, in a processing method according to the embodiment, an agent is introduced into a work PC (terminal) used by each staff to collect operation data (operation log) ((1) in FIG. 1). In the work PC, Windows (registered trademark) is used as the OS. Note that the OS of the work PC may be an OS other than Windows. Moreover, each staff may use a tablet or the like instead of the work PC. In the present embodiment, an operation characteristic having a high correlation with an individual's proficiency level is extracted from an operation log as a proficiency element (feature amount) ((2) in FIG. 1). Moreover, in the present embodiment, each work difficulty level, such as a work difficulty level coefficient (weighting value), is calculated by statistically analyzing proficiency elements of a plurality of staffs ((3) in FIG. 1).

In the present embodiment, the proficiency level of each staff is calculated on the basis of proficiency elements highly correlated with the proficiency level, such as speed (required time, shortcut, copy) and accuracy (correction), in consideration of the work difficulty level ((4) and (5) in FIG. 1). In other words, in the present embodiment, it is possible to quantitatively grasp the proficiency level of staff in consideration of the work difficulty level and work accuracy ((6) in FIG. 1). Then, according to the proficiency level calculated for each staff, it is possible to appropriately allocate staff according to the proficiency level of each staff and productivity that can be estimated from the proficiency level, whereby productivity of the organization can be improved.

### [Processing Device]

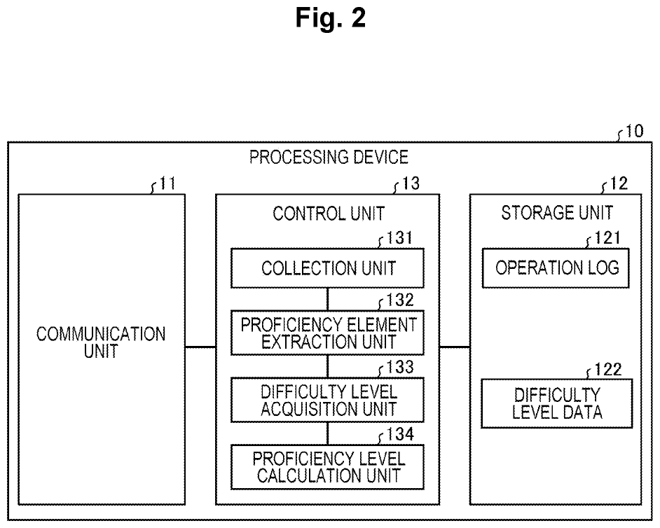

Next, a processing device that calculates the proficiency level of each staff will be described. FIG. 2 is a diagram schematically illustrating an example of a configuration of the processing device according to the embodiment. A processing device 10 according to Embodiment 1 illustrated in FIG. 2 includes a communication unit 11, a storage unit 12, and a control unit 13.

The communication unit 11 is a communication interface that transmits and receives various types of information to and from another device connected via a network or the like. For example, the communication unit 11 is implemented by a network interface card (NIC) or the like, and performs communication between the other device and the control unit 13 (described later) via a telecommunication line such as a local area network (LAN) or the Internet. For example, the communication unit 11 receives an operation log from the work PC of each staff via the network and outputs the operation log to the control unit 13. Moreover, the communication unit 11 outputs information indicating the proficiency level of each staff calculated by the control unit 13 to an external device via a network.

The storage unit 12 is a storage device such as a hard disk drive (HDD), a solid state drive (SSD), or an optical disc. Note that the storage unit 12 may be a semiconductor memory capable of rewriting data, such as a random access memory (RAM), a flash memory, or a non volatile static random access memory (NVSRAM). The storage unit 12 stores an operating system (OS) and various programs executed by the processing device 10. Furthermore, the storage unit 12 stores various types of information used for executing the programs. The storage unit 12 stores an operation log 121 of the work PC used by each staff and difficulty level data 122 indicating each work difficulty level.

The control unit 13 controls the entire processing device 10. The control unit 13 includes, for example, an electronic circuit such as a central processing unit (CPU) or a micro processing unit (MPU), or an integrated circuit such as an application specific integrated circuit (ASIC) or a field programmable gate array (FPGA). Moreover, the control unit 13 includes an internal memory for storing programs and control data defining various processing procedures, and executes each of the types of processing by using the internal memory. Moreover, the control unit 13 functions as various processing units by operation of various programs. The control unit 13 includes a collection unit 131, a proficiency element extraction unit 132 (extraction unit), a difficulty level acquisition unit 133, and a proficiency level calculation unit 134 (calculation unit).

The collection unit 131 collects operation logs of work PCs of a plurality of staffs. The collection unit 131 acquires an event that occurs when a focus (screen element to be operated by staff) moves using an application programming interface (API) provided by Windows, thereby acquiring an operation log for an operation target across systems (applications). Note that the work PC and the storage unit 12 (see FIG. 2) directly acquire the log itself, and the collected log may be aggregated by another terminal, a server, or the storage unit 12 (see FIG. 2).

The proficiency element extraction unit 132 extracts proficiency elements for each staff from the operation log collected by the collection unit 131. There is a plurality of types of proficiency elements. Proficiency elements include, for example, the number of times of use of the alt key on the keyboard of the work PC, the number of times of use of a mouse connected to the work PC, and the number of times of paste operation among operations in the work PC, which are acquired as the operation log.

The difficulty level acquisition unit 133 acquires a work difficulty level coefficient for each work performed by each staff. The work difficulty level coefficient is used as a weighting value for correcting the deviation between works when the proficiency level calculation unit 134 calculates the proficiency level of each staff. The difficulty level acquisition unit 133 calculates a work difficulty level coefficient on the basis of a plurality of operation logs corresponding to the plurality of staffs. The difficulty level acquisition unit 133 calculates a work-year latitude coefficient that increases as the time required for the work increases or a work difficulty level coefficient that increases as the error rate increases on the basis of the operation performed by the staff when the operation log is collected.

The work difficulty level coefficient is a value obtained at a predetermined timing for each work environment of the staff. The work environment is a group or a site that performs a certain operation. For example, the difficulty level acquisition unit 133 periodically calculates a work difficulty level coefficient and stores the work difficulty level coefficient in the storage unit 12. Alternatively, the difficulty level acquisition unit 133 calculates the work difficulty level coefficient at a timing when the work environment changes. Moreover, the difficulty level acquisition unit 133 may appropriately adjust the work difficulty level coefficient within a period in which the work has been performed. Moreover, the difficulty level acquisition unit 133 may change the calculation timing of the work difficulty level coefficient according to the work.

The proficiency level calculation unit 134 calculates the proficiency level of work for each staff from proficiency elements generated for each staff. The proficiency level calculation unit 134 calculates the proficiency level of each staff from the proficiency element on the basis of a relationship between the proficiency element and the proficiency level. The proficiency level calculation unit 134 calculates the proficiency level of each staff on the basis of a relationship between the proficiency element and the proficiency level that is obtained in advance in which the proficiency level increases as the number of uses of the alt key increases, the proficiency level increases as the number of uses of the mouse decreases, and the proficiency level increases as the number of paste operations decreases. The proficiency level calculation unit 134 selects a proficiency element of a type corresponding to the work environment of the staff from among the plurality of proficiency elements, and calculates the proficiency level of each staff on the basis of the selected type of proficiency element.

Then, the proficiency level calculation unit 134 uses the work difficulty level coefficient as a weighting value for correcting the deviation between works. The proficiency level calculation unit 134 calculates the proficiency level by weighting with a work difficulty level coefficient that increases as the time required for the work increases or a work difficulty level coefficient that increases as the error rate increases, on the basis of the work performed by the staff when the operation log is collected.

### [Collection Unit]

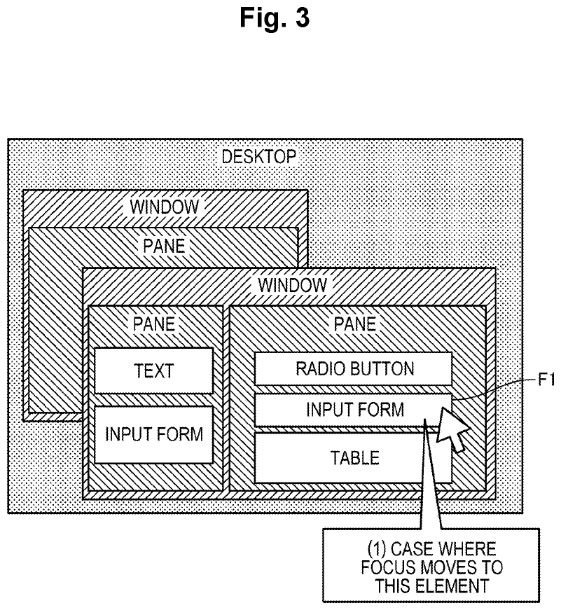

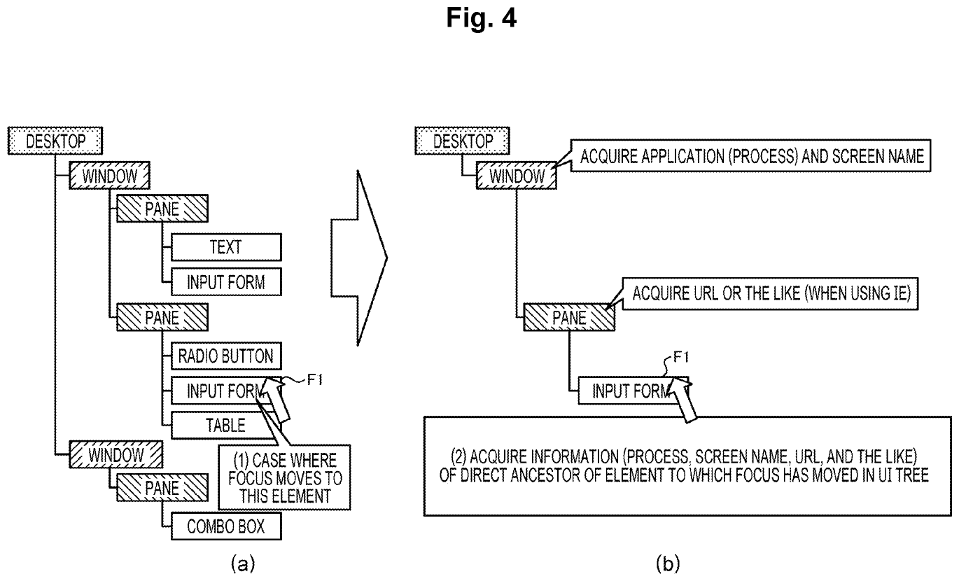

Next, each functional unit of the processing device 10 will be described. First, the collection unit 131 will be described. FIG. 3 is a diagram illustrating an example of a desktop screen of Windows. FIG. 4 is a diagram illustrating a UI tree.

The collection unit 131 uses an API provided by Windows to acquire an event that occurs when a focus (screen element to be operated) moves, thereby achieving acquisition of information to be operated across systems (applications).

For example, a case where the focus moves to an element of an input form F1 ((1) in FIGS. 3 and 4) will be described as an example. The collection unit 131 can obtain a process or a window title displaying the form by tracing back the UI tree ((a) of FIG. 4) managed by Windows to the desktop for the element in the screen to which the focus has moved. The collection unit 131 may identify a system name by using a process name, or may acquire a window title determined by the system. Note that the display of the window title is determined by the system and its state. For example, in the case of Internet Explorer (IE), the window title is different for each URL. The window title can be acquired from the UI tree in response to focus movement or clicking.

Here, the collection unit 131 acquires only the focused element (e.g., input form F1) and information (process, screen name, URL, and the like) of the direct ancestor of this element in the UI tree as an operation log ((2) in FIG. 4). For example, for the input form F1, the collection unit 131 acquires information of a pane, (URL or the like in the case of IE) which is a diameter ancestor of the input form F1, a window (process or window title and screen name thereof), and the desktop. The collection unit 131 uses information of a direct ancestor of the focused element in the UI tree, thereby achieving both output of an operation log having a smaller data amount than the entire tree and extraction of proficiency elements at a level of detail and granularity sufficient for analysis.

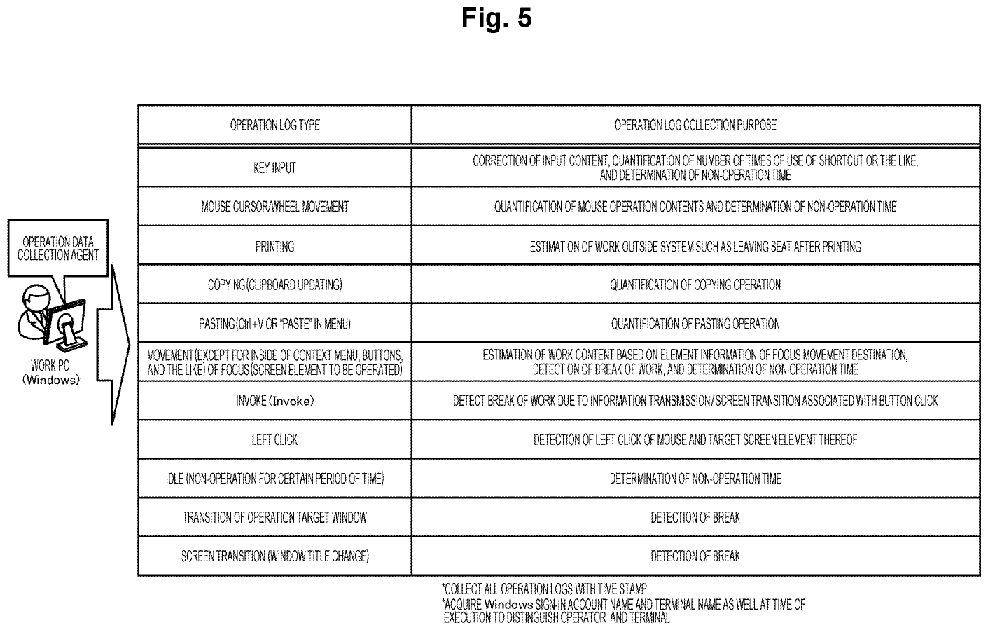

FIG. 5 is a diagram illustrating operation logs collected by the collection unit 131 illustrated in FIG. 2 and collection purposes thereof. As illustrated in FIG. 5, the collection unit 131 collects an operation log of key input to correct input contents, quantify the number of times of use of a shortcut or the like, and determine non-operation time. The collection unit 131 collects an operation log of mouse cursor/wheel movement to quantify mouse operation contents and determine non-operation time. The collection unit 131 collects an operation log of printing to estimate work outside the system such as leaving the seat after printing.

The collection unit 131 collects an operation log of copying (clipboard updating) to quantify the copying operation. The collection unit 131 collects an operation log of pasting (Ctrl+V or “paste” in menu) to quantify the pasting operation. The collection unit 131 collects an operation log of moving (except for inside of context menu, buttons, and the like) the focus (screen element to be operated) to estimate a work content based on element information of a focus movement destination, detect a break of a work, and determine non-operation time. The collection unit 131 collects an operation log of invoking to detect a break of a work due to information transmission/screen transition associated with a button click.

The collection unit 131 collects an operation log of a left click of the mouse to detect a left click and a target screen element thereof. The collection unit 131 collects non-operation for a certain period of time or more as an idle operation log. The collection unit 131 collects an operation log of transitioning of the operation target window to detect a break. The collection unit 131 collects an operation log of screen transition (window title change) to detect a break.

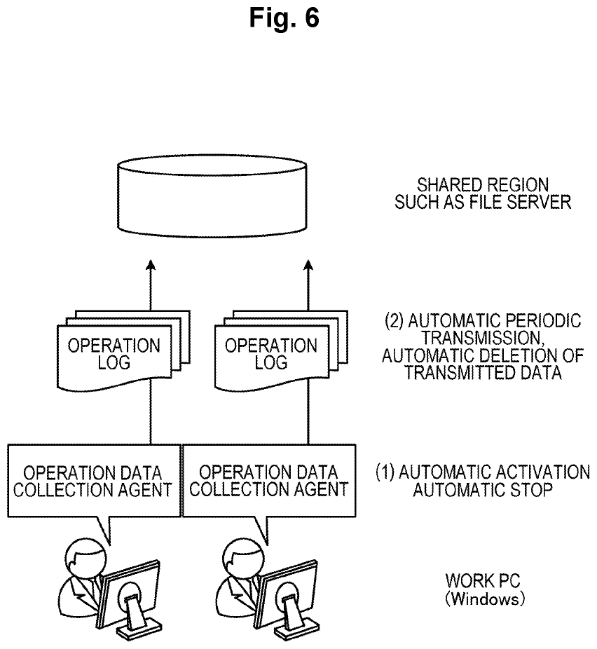

FIG. 6 is a diagram for describing a function of the operation data collection agent. The collection unit 131 sets the function of the operation data collection agent as follows. The operation data collection agent is automatically activated at the time of PC activation (sign-in) by startup registration, and is automatically stopped by sign-out detection ((1) in FIG. 6). As a result, it is possible to reduce the burden on the user, curb output of agent activation and stop operations themselves as operation logs, and curb loss of operation logs due to forgetting of the activation and stop operations.

Moreover, the operation data collection agent sequentially outputs the operation logs to a predetermined file set in advance, and automatically transmits (copies to set file path) the predetermined file as the operation log to a file server periodically (initially set to every one hour) ((2) in FIG. 6). As a result, conversion processing from quantified data for a plurality of persons to proficiency element data and subsequent analysis processing and score calculation can be unified, and aggregation of data for a plurality of persons can be facilitated. Moreover, the range of data loss due to a failure or the like on the work PC side can be limited in units of transmission intervals. Note that the work PC may transmit the operation log or a proficiency level factor to the processing device 10 that determines proficiency like streaming instead of outputting to the log file.

Then, the operation data collection agent automatically deletes an operation log file that has been successfully transmitted and a file for which a certain period (initial value: one month) has elapsed ((2) in FIG. 6). As a result, it is possible to curb the influence of the work PC on storage resources and to limit the range of data loss in a data holding period due to a failure or the like on the file server side.

### [Proficiency Element Extraction Unit]

Next, the proficiency element extraction unit 132 will be described. The proficiency element extraction unit 132 extracts a proficiency element by converting an operation log into data (quantified data) quantitatively representing the behavior of a staff during work for each staff. What element the feature amount of the proficiency element should be made should be designed according to the characteristics of the group or the work. Suitable elements are different depending on the group or site that performs a certain work and the characteristics of the work. For example, the feature amount can be made by an element (input form, button, or the like) in the UI. Since the proficiency element can finely analyze the behavior of a staff, for example, there is a possibility that the proficiency element can finely point out habits, poor work, and the like and promote improvement. Then, the proficiency element extraction unit 132 quantifies behavior such as the number of times of shortcut, copy, paste, and use of backspace/delete keys for each staff, and can mainly analyze a viewpoint other than the required time for data collection, such as operation characteristics and accuracy of an individual.

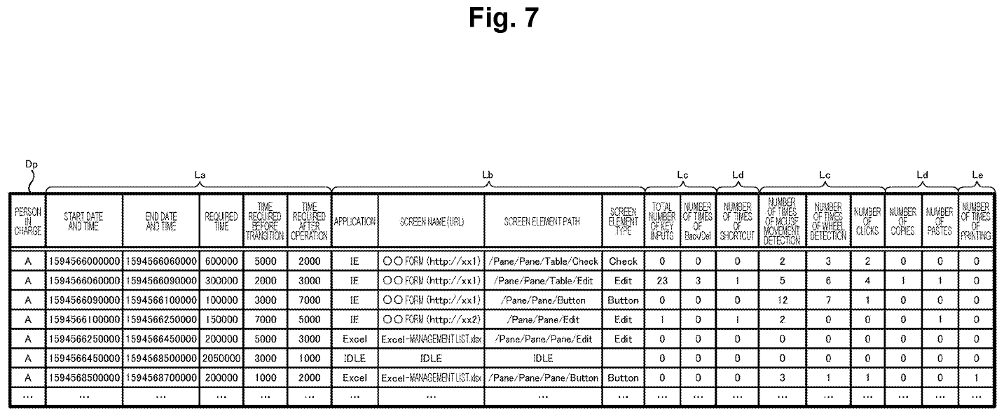

Specifically, an extraction degree element extracted by the proficiency element extraction unit 132 will be described. FIG. 7 is a diagram illustrating a list of proficiency elements extracted from an operation log. A list Dp illustrated in FIG. 7 exemplifies a case where operation data of a staff A is extracted from a plurality of operation logs, various operation counts are extracted for each period, and quantified. Note that the list Dp is intermediate data processed by the proficiency element extraction unit 132, and, for example, selection of an item or processing of each numerical value is performed according to the work environment of the staff A or a period for which the proficiency level is desired to be calculated.

The list Dp includes, for example, items of a person in charge, a start date and time, an end date and time, a required time, a time required before transition, a time required after operation, an application, a screen name (URL), a screen element path, a screen element type, the total number of key inputs, the number of times of back/del (number of times of backspace/delete key), the number of times of shortcut, the number of times of mouse movement detection, the number of times of wheel detection, the number of clicks, the number of copies, the number of pastes, and the number of times of printing.

The person in charge item is a sign-in account name or a selected name, and the list Dp exemplifies a case where proficiency elements of the staff A are extracted. The start date and time and the end date and time are UNIX (registered trademark) milliseconds (time stamp not affected by time difference). The required time is obtained from the start date and time and the end date and time, and the unit is millisecond. The time required before transition is a required time of only the mouse movement/wheel detection at the end of the required time of the previous record in the operation order. The time required after operation is a required time of only the mouse movement/wheel detection at the end of the required time of the current record. In the screen name (URL), the URL is also added only in the case of IE and in the case where the URL can be acquired.

In the screen element path, not all screen elements (forms and the like) are named, and thus an expression using the UI tree structure is used as an identifier. Note that even in a case where a title bar or a blank in a screen is clicked to simply set the window to the foreground, the motion is output as one record. However, it is considered that the record can be removed by rules such as the required time, the screen element type, and the total number of key inputs at the time of analysis.

The number of times of shortcut is actually divided into columns such as Ctrl+, Win+, Alt+, Tab, and F2 to F12. The number of times of mouse movement detection is counted, for example, by regarding cursor movement of 100 pixels or more in either the horizontal or vertical direction as one time. The number of times of wheel detection is detected at intervals of 0.1 seconds. The number of times of mouse movement detection is regarded as one when the mouse movement is detected a plurality of times within 0.1 seconds. In a case where an application mouse in which smooth scrolling is enabled is used, a large amount of wheel operation is detected in a short time, and thus, a certain detection interval is provided. In the number of clicks, it is also possible to distinguish among left, center, and right clicks.

The start date and time, the end date and time, the required time, the time required before transition, and the time required after operation (La in FIG. 7) are used for analyzing the proficiency level of the staff. For example, in a case where the required time average value of all staffs is large, this work is regarded as a bottleneck. Moreover, in a case where the required time is short with respect to the staff average, it can be regarded that this work is a work that the staff A is good at, and in a case where the required time is long, it can be regarded that this work is a work that the staff A is not good at.

The application, the screen name (URL), the screen element path, and the screen element type (Lb in FIG. 7) are used for identifying a series of work, in other words, to identify the work part. The total number of key inputs, the number of times of back/del, the number of times of mouse movement detection, the number of times of wheel detection, and the number of clicks (Lc in FIG. 7) are used for analyzing the proficiency level of the staff. For example, in the item of Lc in FIG. 7, in a case where the average value of all staffs is large, it can be regarded that this work is a bottleneck, in a case where the numerical value is small with respect to the staff average, it can be regarded that this work is a work that the staff A is good at, and in a case where the numerical value is small, it can be regarded that this work a work that the staff A is not good at.

The number of shortcuts, the number of copies, and the number of pastes (Ld in FIG. 7) are used for analyzing the proficiency level of the staff. For example, in the item of Ld in FIG. 7, when the numerical value is large, there is a possibility that the staff operates at high efficiency and contributes to reduction of required time, and the like. Moreover, the number of times of printing (Le in FIG. 7) is used for validity analysis of idle time. The correlation between each item described above and the proficiency level will be described in the processing description of the proficiency level calculation unit 134.

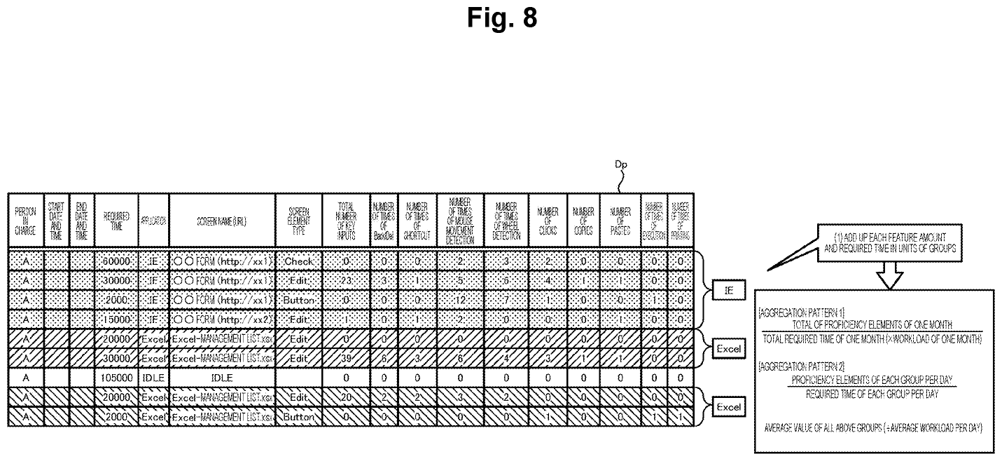

Then, the proficiency element extraction unit 132 may aggregate proficiency elements in a certain unit of the operation log. FIG. 8 is a diagram for describing an aggregation pattern of proficiency elements. The proficiency element extraction unit 132 considers, for each staff, operations performed while focusing on a certain application as a group, aggregates operation contents (number of operations and time) for each group, and sets the operation contents as proficiency elements for the staff. At that time, the proficiency element extraction unit 132 also performs counting in which the influence of the number of cases is reduced by dividing each proficiency element by the workload.

Specifically, the proficiency element extraction unit 132 adds up each feature amount (proficiency element) and the required time in units of groups (application (such as IE)) ((1) in FIG. 8). Then, the proficiency element extraction unit 132 aggregates proficiency elements using, for example, Aggregation pattern 1 or Aggregation pattern 2. As a result, in Aggregation pattern 1, a proficiency element record of the number of staffs×2 (Months: October, November) is created, and in Aggregation pattern 2, the proficiency element record corresponding to the number of staffs×the number of days for which data exists is created.

### [Difficulty Level Acquisition Unit]

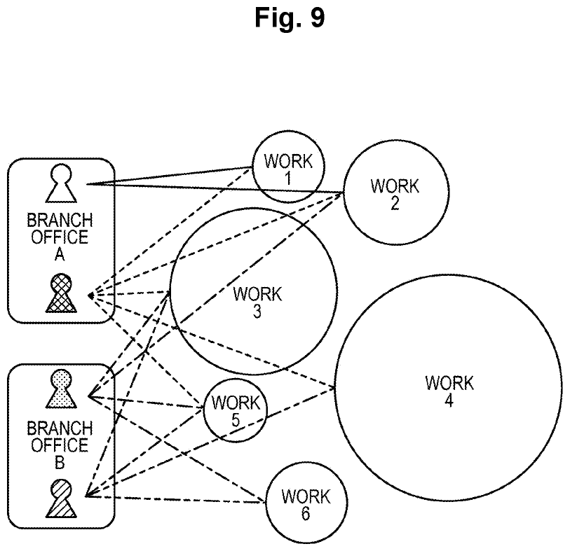

Next, the work difficulty level coefficient and the difficulty level acquisition unit 133 will be described. FIG. 9 is a diagram in which staff and work executed by each staff are associated with each other.

As illustrated in FIG. 9, a plurality of staffs may perform a plurality of types of works having different work difficulty levels during a certain period. Moreover, there is a case where the same staff performs the same work a plurality of times. In such a case, comparison of the proficiency levels of staffs using scores calculated only by the speed of work (required time) is not accurate. Therefore, in the present embodiment, the proficiency level score is corrected by performing weighting for each work (by multiplying work difficulty level coefficient), and the proficiency level score reflecting the work skill level more fairly and objectively is calculated.

It is necessary to reflect the average value and variance of the speed and accuracy of the work (rate of backspace/del keys) in the work difficulty level coefficient. Therefore, the work difficulty level coefficient needs to satisfy the following conditions (1) to (3).
(1) The work difficulty level coefficient is a numerical value within a certain value range. The work difficulty level coefficient is designed to be a coefficient of zero to one, for example, to be used for weighting for each work when calculating the proficiency level.
(2) The larger the average required time and the average error rate (the larger the volume of work), the larger the value.
(3) The value increases as the variation in the average required time and average error rate increases depending on the staff (there is a large difference in skill of work, and there is a large room for learning).

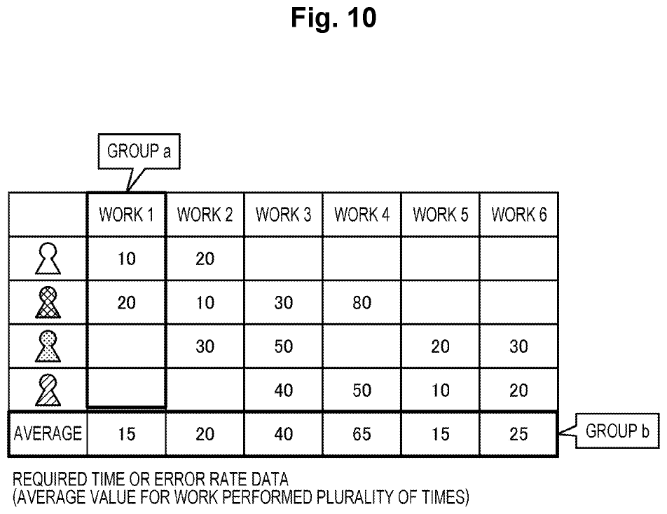

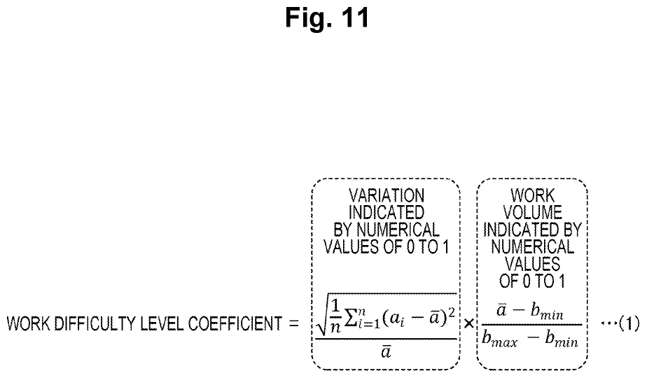

FIG. 10 is a diagram illustrating required time or error rate data when staffs perform work. The required time at the time of performing work is the time required for the staff to finish the work. The error rate at the time of performing work is, for example, a ratio of the number of times of use of the backspace/delete key to the total number of key inputs of the staff. FIG. 11 is a diagram illustrating a calculation formula of the work difficulty level coefficient. FIG. 10 illustrates a set (set a) of the required time for the work or the error rate data for the work and a set (set b) of average values of the required time or error rate data for the work, for work performed a plurality of times, applied to Formula (1) described later.

The difficulty level acquisition unit 133 obtains a coefficient that satisfies the condition of the work difficulty level by Formula (1) in FIG. 11, for example. The difficulty level acquisition unit 133 obtains a coefficient for each work type by Formula (1) in both the required time and the accuracy (error rate) of the work. As shown in Formula (1), the value of this coefficient increases as the time required for work increases. Moreover, the value of this coefficient increases as the error rate increases. The difficulty level acquisition unit 133 uses Formula (1) for both the required time and the accuracy. Then, the difficulty level acquisition unit 133 sets a value obtained by multiplying the coefficient calculated using Formula (1) for the required time and the coefficient calculated using Formula (1) for the error rate as the work difficulty level coefficient of the work. Therefore, the work difficulty level coefficient increases as the time required for the work increases, or increases as the error rate increases. Note that the difficulty level acquisition unit 133 may calculate the coefficients of all the work types and then normalize the work difficulty level coefficients.

The difficulty level acquisition unit 133 periodically calculates the work difficulty level coefficient. Moreover, the difficulty level acquisition unit 133 calculates a work difficulty level coefficient in a case where the work environment changes. The difficulty level acquisition unit 133 outputs the calculated work difficulty level coefficient of each work to the proficiency level calculation unit 134. Moreover, the difficulty level acquisition unit 133 stores the calculated work difficulty level coefficient of each work in the storage unit 12.

### [Proficiency Level Calculation Unit]

Next, the proficiency level calculation unit 134 will be described. The proficiency level calculation unit 134 calculates the proficiency level of each staff on the basis of a relationship between proficiency elements and the proficiency level of each staff. Operation logs of 19 persons who perform a slip insertion proxy work for a total of 18 business days were actually acquired, and a relationship between values of the proficiency elements extracted from the operation data of each staff and the proficiency level was obtained.

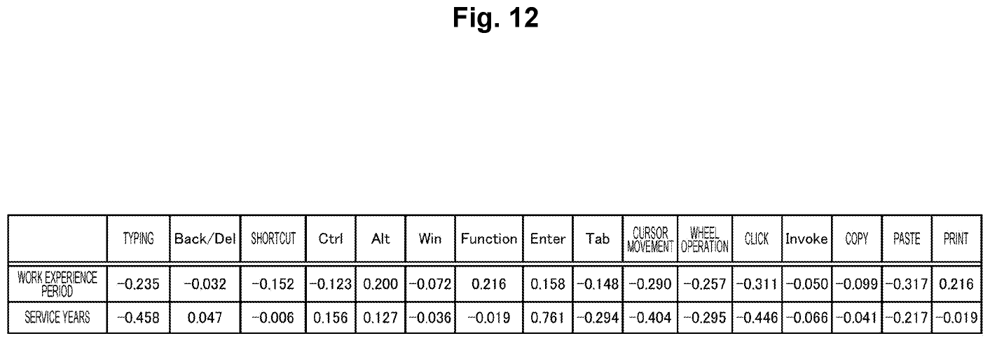

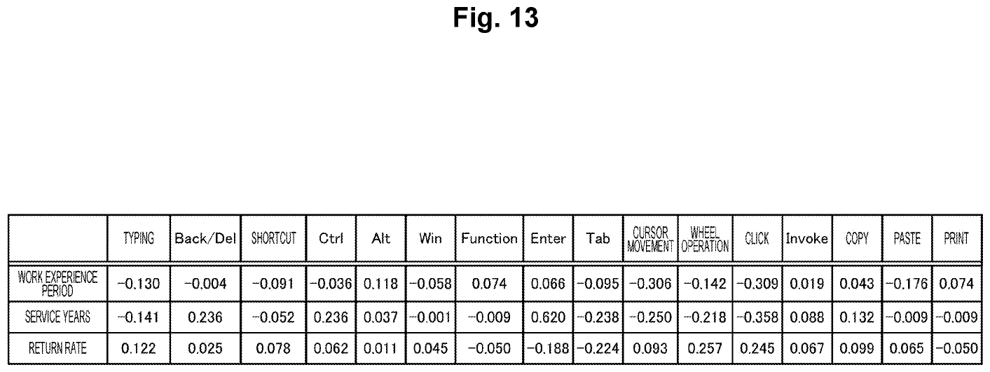

FIGS. 12 and 13 are diagrams illustrating tables in which a team's work experience period, service years, a return rate, and a correlation coefficient with proficiency elements are associated with each other. Note that the return rate indicates a rate at which a form is created but is taken back due to an error with respect to the number of forms created. The work experience period, the service years, and the return rate are indices that are examples of the proficiency level.

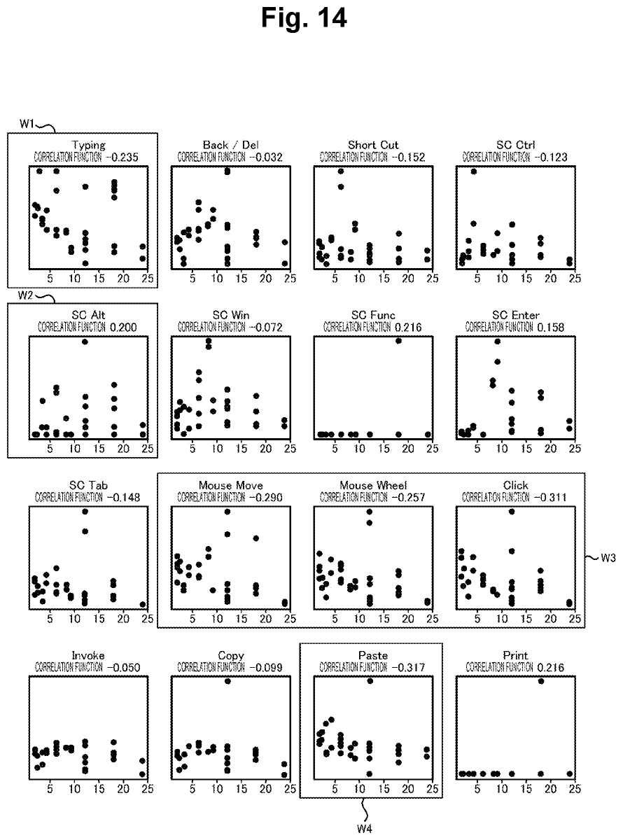

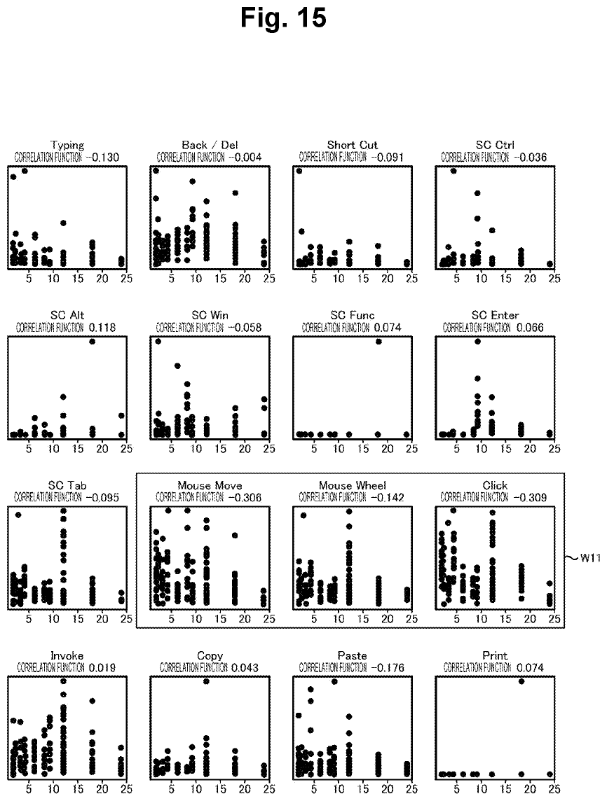

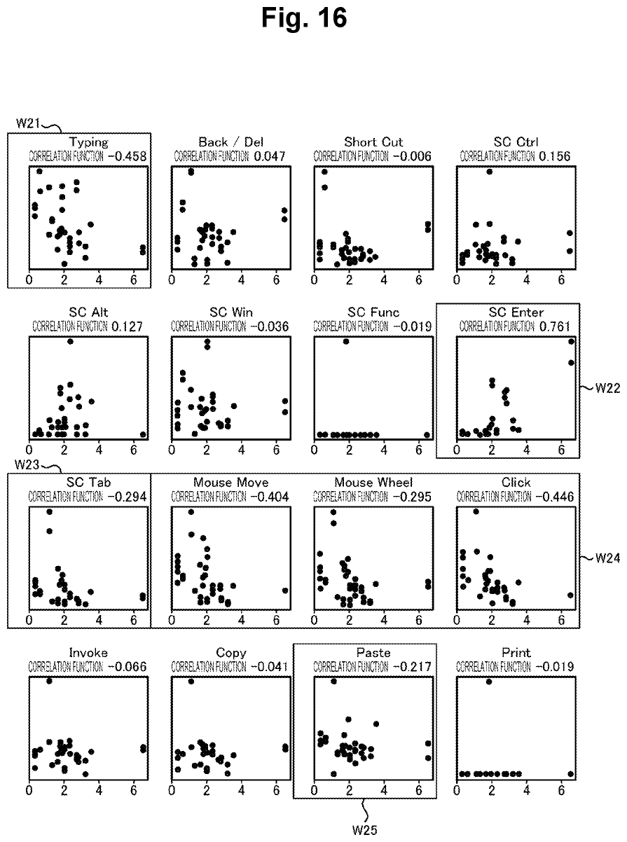

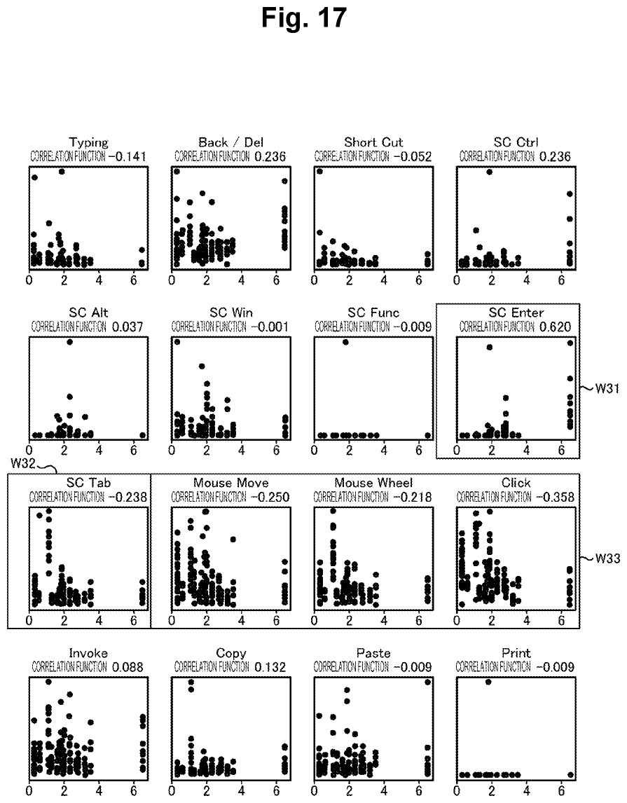

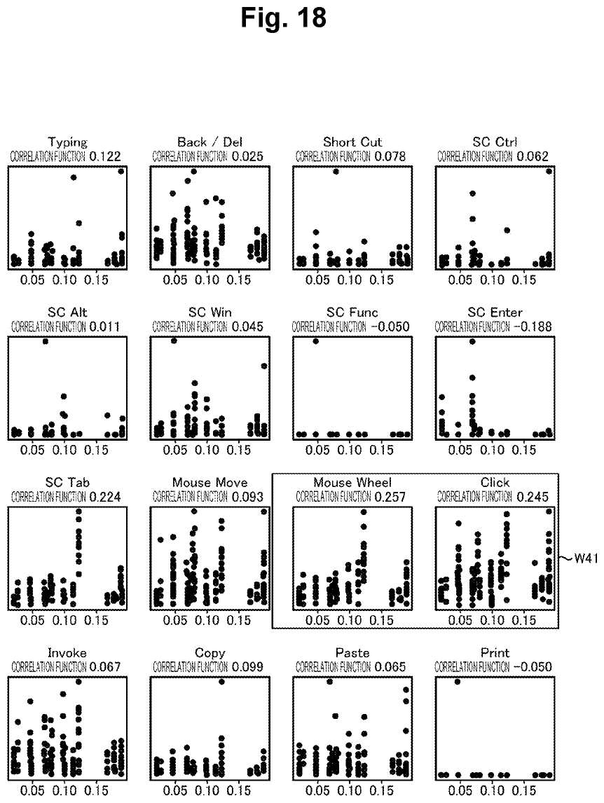

FIG. 12 illustrates the relationship between the proficiency elements aggregated in Aggregation pattern 1 and the proficiency level, and FIG. 13 illustrates the relationship between the proficiency elements aggregated in Aggregation pattern 2 and the proficiency level. FIGS. 14 and 15 are diagrams in which values of proficiency elements are associated with the work experience period of the team. FIGS. 16 and 17 are diagrams in which values of proficiency elements are associated with years of work experience. FIG. 18 is a diagram in which values of proficiency elements are associated with the return rate. In FIGS. 14 and 16, proficiency elements aggregated in Aggregation pattern 1 are used. In FIGS. 15, 17, and 18, proficiency elements aggregated in Aggregation pattern 2 are used.

In FIGS. 16 to 18, the total number of key inputs (typing), the number of times of back/del (back/del), the number of times of shortcut (short cut), the number of times of shortcut using the ctrl key (SC_Ctrl), the number of times of shortcut using the alt key (SC_Alt), the number of times of shortcut using the Win key (SC_Win), the number of times of shortcut using the function key (SC_Func), the number of times of shortcut using the enter key (SC_Enter), the number of times of shortcut using the tab key (SC_Tab), the number of mouse movement detections (Mouse Move), the number of wheel detections (Mouse Wheel), the number of clicks (Click), the number of times of invoking detections (Invoke), the number of times of copy (Copy), the number of times of paste (Paste), and the number of times of printing (Print) are illustrated as proficiency elements.

As illustrated in FIG. 8 and a frame W1 in FIG. 14, typing tends to be less as the work experience period of the team is longer. As illustrated in FIGS. 12 and 13, and a frame W2 in FIG. 14, the alt key tends to be used more as the work experience period of the team is longer. Moreover, as illustrated in FIGS. 12 and 13, a frame W3 in FIG. 14, and a frame W13 in FIG. 15, the movement of the mouse cursor/wheel and the number of clicks tend to be smaller as the work experience of the team is longer. Moreover, as illustrated in FIGS. 12 and 13 and a frame W4 in FIG. 14, the number of times of pasting tends to be smaller as the work experience of the team is longer.

As described above, among the proficiency elements, the number of times of typing, the shortcut using the alt key, and the number of times of use of the mouse indicating the movement of the mouse cursor/wheel and the number of clicks are considered to have a certain relationship with the work experience period.

Moreover, as illustrated in FIGS. 12 and 13 and a frame W21 in FIG. 16, typing tends to be less as the service years are longer. As indicated by FIGS. 12 and 13, a frame W22 in FIG. 16, and a frame W31 in FIG. 17, the number of times of the enter key tends to increase as the service years are longer. As indicated by FIGS. 12 and 13, and a frame W23 in FIG. 16, and a frame W32 in FIG. 17, the number of times of the tab key tends to be smaller as the service years are longer. As indicated by FIGS. 12 and 13, a frame W24 in FIG. 16, and a frame W33 in FIG. 17, the movement of the mouse cursor/wheel and the number of clicks tend to be smaller as the service years are longer. Moreover, as indicated by FIGS. 12 and 13 and a frame W25 in FIG. 16, the number of pastes tends to decrease as the service years are longer.

As described above, among the proficiency elements, the number of times of typing, the number of times of the enter key, the number of times of the tab key, the number of times of use of the mouse indicating the movement of the mouse cursor/wheel and the number of clicks, and the number of times of pasting are considered to have a certain relationship with the number of working years.

Moreover, as indicated by FIGS. 12 and 13 and a frame W41 in FIG. 18, the movement of the mouse cursor/wheel and the number of clicks tend to be smaller as the return rate is higher. As described above, among the proficiency elements, the number of times of use of the mouse indicating the movement of the mouse cursor/wheel and the number of clicks are considered to have a certain relationship with the return rate.

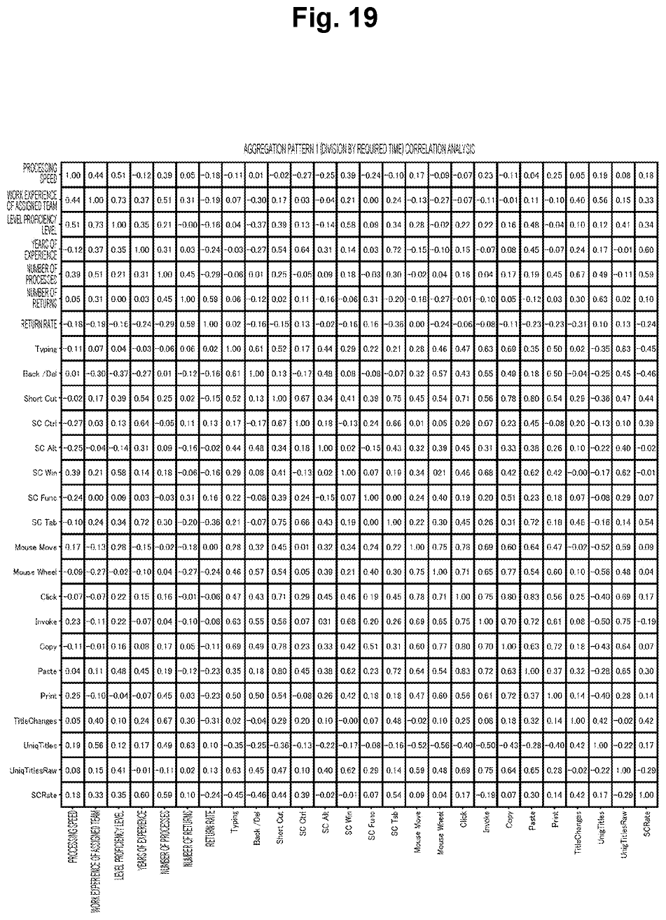

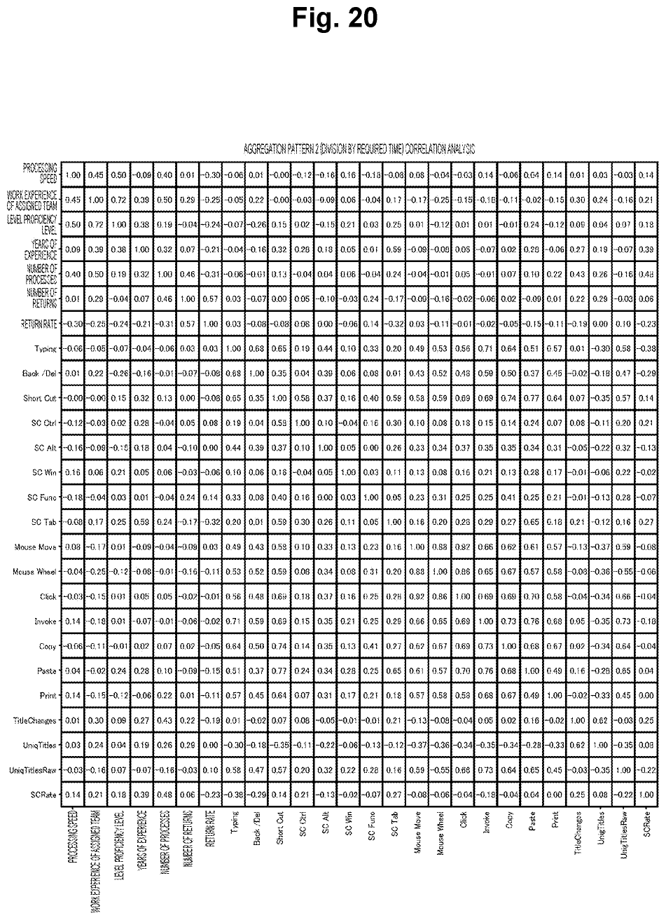

FIGS. 19 and 20 are diagrams illustrating correlation coefficients between the index and the proficiency element. FIG. 19 illustrates a correlation coefficient between the index and the proficiency element aggregated in Aggregation pattern 1. FIG. 20 illustrates a correlation coefficient between the index and the proficiency element aggregated in Aggregation pattern 2.

Unlike FIGS. 14 to 18, FIGS. 19 and 20 are obtained by aggregating proficiency elements only from data during IE operation mainly used on work and performing correlation analysis. Then, not only various operation frequencies but also TitleChanges, UniqTitles, UniqTitlesRaw, and SCRate were added as proficiency elements. TitleChanges is a frequency at which the window title changes. UniqTitles is the frequency of window titles excluding duplicate titles. UniqTitlesRaw is the number of window titles excluding duplicate titles, and is the value itself rather than the frequency divided by the required time. SCRate is a ratio of the number of shortcut operations to the total number of key operations.

In FIGS. 19 and 20, the processing speed (manager's subjective view), the work experience of the assigned team, the level proficiency level (manager's subjective view), the number of processes, the number of returns, and the return rate are indices that are examples of the proficiency level. In FIGS. 19 and 20, the correlation coefficient between the index and the proficiency element is entered in a part where the index and the proficiency element intersect. The relationship between the proficiency element and the index can be recognized by looking at the correlation coefficient at the intersection of the index and the proficiency element. Therefore, the proficiency element to be used for calculation of the proficiency level may be selected in consideration of the relationship between the index and the proficiency element.

As described above, according to the type of proficiency element, the proficiency element has a relationship with the work experience period of the assigned team, the service years, the processing speed (manager's subjective view), the level proficiency level (manager's subjective view), the number of processes, the number of returns, and the return rate, which are indices as examples of the proficiency level. On the basis of such a relationship between the proficiency element and the proficiency level, the proficiency level calculation unit 134 selects a proficiency element corresponding to the work environment of a staff, and calculates the proficiency level of each staff. Therefore, first, the proficiency level calculation unit 134 selects a proficiency element of a type according to the work environment for each work environment of a staff.

Then, the proficiency level calculation unit 134 obtains the proficiency level using a corresponding proficiency level calculation model for each work environment. This proficiency level calculation model is obtained by learning in advance, as teacher data, a data set including a proficiency level given in advance to a staff and a proficiency element selected in accordance with a work environment. Each proficiency level calculation model learns a data set of a proficiency element selected in accordance with each work environment and a proficiency level given in advance to a staff. The proficiency level calculation unit 134 selects a proficiency level calculation model corresponding to the work environment of the proficiency level calculation target staff, inputs proficiency elements of the proficiency level calculation target staff to the selected proficiency level calculation model, and acquires the output proficiency level to obtain the proficiency level of the staff.

Moreover, the proficiency level calculation unit 134 may calculate the proficiency level of each staff using a preset arithmetic expression for each work environment of the staff. In this case, the proficiency level calculation unit 134 calculates the proficiency level of the proficiency level calculation target staff by applying a proficiency element to an arithmetic expression, the proficiency element being selected according to each work environment from among the proficiency elements of the proficiency level calculation target staff.

The arithmetic expression for calculating the proficiency level is designed as follows, for example, on the basis of the relationships in FIGS. 12, 13, 19, and 20. The arithmetic expression is designed to be lower as the time required for typing increases, higher as the specification of the alt key increases, and lower as the cursor movement, the wheel operation, and the click increase. The arithmetic expression may be designed to be lower as the use of the mouse such as cursor movement, wheel operation, and click operation increases. Moreover, the proficiency element having a positive correlation between the proficiency level and the work experience period, the service years, or the return rate may be directly applied to the arithmetic expression. For the proficiency element having a negative correlation between the proficiency level and the work experience period, the service years, or the return rate, the sum of inverses of the values of the element may be used. Moreover, when only one of the values is positive, the arithmetic expression may be designed according to the purpose.

### [Processing Procedure of Processing Method]

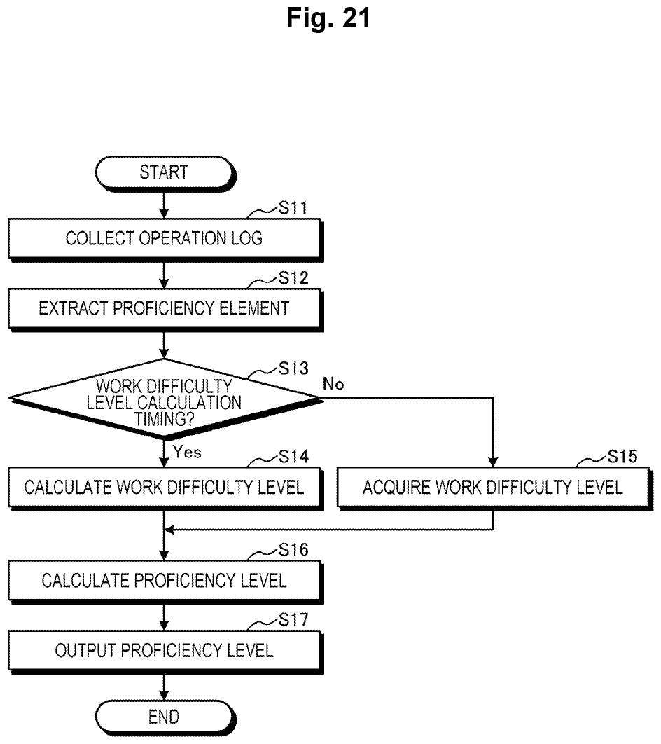

FIG. 21 is a flowchart illustrating a processing procedure of a processing method according to the embodiment. As illustrated in FIG. 21, in the processing device 10, the collection unit 131 collects operation logs of the work PCs of a plurality of staffs (step S11). Subsequently, the proficiency element extraction unit 132 extracts proficiency elements for each staff from the operation log collected by the collection unit 131 (step S12).

Subsequently, the difficulty level acquisition unit 133 determines whether or not it is a timing to calculate the work difficulty level coefficient (step S13). The calculation timing of the work difficulty level coefficient is when a predetermined period has elapsed from the previous calculation, when the work environment has changed, or the like.

If it is a timing to calculate the work difficulty level coefficient (step S13: Yes), the difficulty level acquisition unit 133 calculates the work difficulty level coefficient of each work using, for example, Formula (1) in FIG. 11 (step S14). Moreover, if it is not a timing to calculate the work difficulty level coefficient (step S13: No), the difficulty level acquisition unit 133 reads and acquires the work difficulty level coefficient used for calculating the proficiency level from the storage unit 12 (step S15).

The proficiency level calculation unit 134 calculates the proficiency level of work for each staff from proficiency elements generated for each staff (step S16). In step S16, the proficiency level calculation unit 134 selects a proficiency element of a type corresponding to the work environment of the staff from among the plurality of proficiency elements, and calculates the proficiency level of each staff on the basis of the selected type of proficiency element. The proficiency level calculation unit 134 outputs the calculated proficiency level of the staff (step S17).

### Effects of Embodiment

In the embodiment, the operation log of a work PC used by each of a plurality of staffs who perform work is collected, a proficiency element is extracted for each staff from the collected operation logs, and a proficiency level of work is calculated for each staff from the proficiency element extracted for each staff. As described above, in the embodiment, the proficiency level can be appropriately calculated for each staff belonging to an organization. Then, according to the proficiency level calculated for each staff, it is possible to appropriately allocate staff according to the proficiency level of each staff and productivity that can be estimated from the proficiency level, whereby productivity of the organization can be improved.

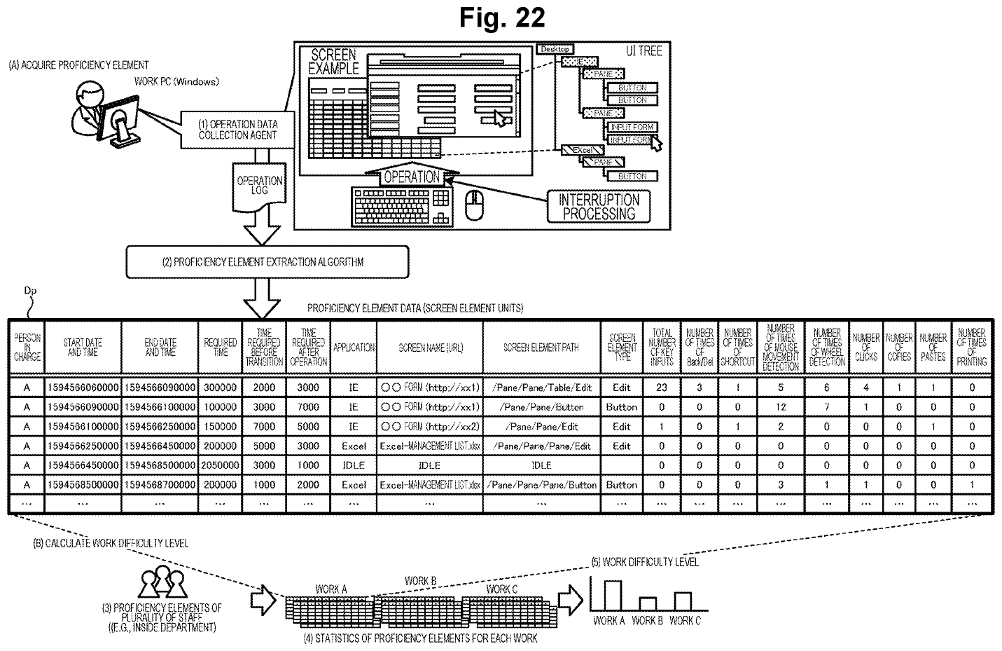

FIG. 22 is a diagram illustrating an outline of the processing method according to the embodiment. As illustrated in FIG. 22, in the present embodiment, in order to acquire a proficiency element, an operation log of each staff is collected using an operation data collection agent. At this time, in the embodiment, an operation target at a granularity of a form unit is determined, and various operation contents such as a mouse, a keyboard operation, printing, copying, and pasting are precisely detected ((A) and (1) in FIG. 22).

In the embodiment, a proficiency element is extracted for each staff from a plurality of operation logs of a plurality of staff using an algorithm for extracting a proficiency element having a relationship with the proficiency level ((2) in FIG. 22). As a result, in the embodiment, by quantifying and aggregating the operation content during screen input at the detailed granularity in units of screen elements, it is possible to extract a proficiency element that contributes to calculation of a proficiency level using not only the required time, but also operation characteristics peculiar to the proficient. Therefore, in the present embodiment, it is possible to calculate the proficiency level including screen elements that an individual is good at or not good at, operation habits, and the like.

Then, in the embodiment, since the proficiency level for each staff is calculated from the proficiency element selected according to the work on the basis of the relationship between the proficiency element and the proficiency level, the proficiency level of each staff can be appropriately calculated.

Furthermore, in the embodiment, statistics of proficiency elements for each work are taken using proficiency elements of a plurality of staffs (e.g., within department or the like), and a work difficulty level coefficient of each work is calculated ((B), (3) to (5) in FIG. 22). In this manner, the work difficulty level coefficient for each work is acquired by statistically analyzing the proficiency elements for a plurality of staffs. In the embodiment, by calculating the proficiency level of each staff while correcting the deviation among works using this work difficulty level coefficient, it is possible to calculate the proficiency level more reflecting the actual situation of the work.

### System Configuration of Embodiment

Each component of the processing device 10 is functionally conceptual, and does not necessarily have to be physically configured as illustrated. That is, specific forms of distribution and integration of the functions of the processing device 10 are not limited to the illustrated forms, and all or a part thereof can be functionally or physically distributed or integrated in any unit according to various loads, usage conditions, and the like.

Moreover, all or any of the processing performed in the processing device 10 may be implemented by a CPU, a graphics processing unit (GPU), and a program analyzed and executed by the CPU and the GPU. Furthermore, each processing performed in the processing device 10, a learning device 20, and a signal processing device 100 may be implemented as hardware by wired logic.

Moreover, among the pieces of processing described in the embodiments, all or some of the processing described as being automatically performed can be manually performed. Alternatively, all or some of the processing described as being performed manually can be automatically performed by a known method. In addition, the above-described and illustrated processing procedures, control procedures, specific names, and information including various data and parameters can be appropriately changed unless otherwise specified.

### [Program]

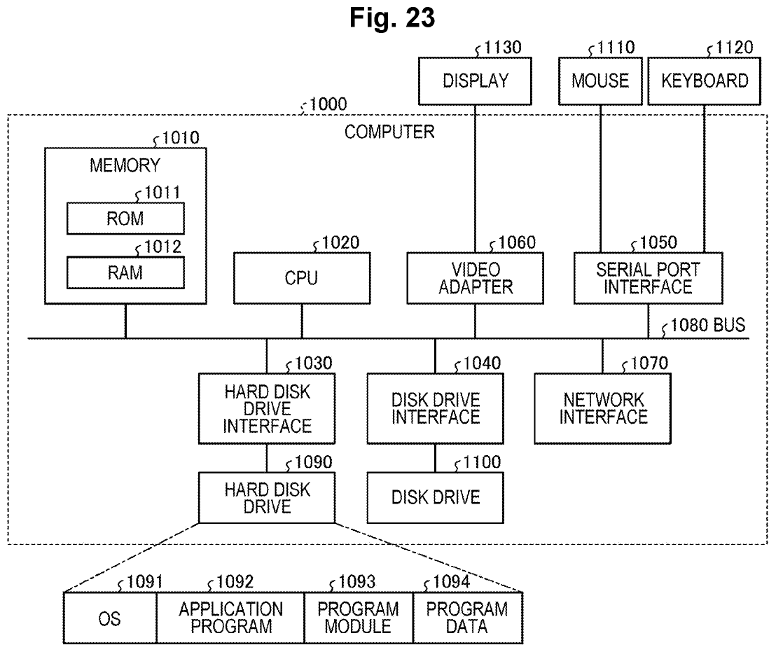

FIG. 23 is a diagram illustrating an example of a computer in which a program is executed to implement the processing device 10. A computer 1000 includes, for example, a memory 1010 and a CPU 1020. Moreover, the computer 1000 further includes a hard disk drive interface 1030, a disk drive interface 1040, a serial port interface 1050, a video adapter 1060, and a network interface 1070. These units are connected to each other by a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, the program that defines each type of processing performed by the processing device 10 is implemented as the program module 1093 in which a code executable by the computer 1000 is described. The program module 1093 is stored in, for example, the hard disk drive 1090. For example, the program module 1093 for executing processing similar to the functional configurations in the processing device 10 is stored in the hard disk drive 1090. Note that the hard disk drive 1090 may be replaced with a solid state drive (SSD).

Moreover, setting data used in the processing of the above-described embodiment is stored, for example, in the memory 1010 or the hard disk drive 1090, as the program data 1094. Then, the CPU 1020 reads and executes the program module 1093 and the program data 1094 stored in the memory 1010 and the hard disk drive 1090 to the RAM 1012 as necessary.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from the other computer via the network interface 1070.

While the embodiment to which the invention made by the present inventors is applied has been described above, the present invention is not limited by the description and drawings included as a part of the disclosure of the present invention according to the present embodiment. That is, other embodiments, examples, operation techniques, and the like made by those skilled in the art and the like on the basis of the present embodiment are all included in the scope of the present invention.

### REFERENCE SIGNS LIST

10 Processing device
11 Communication unit
12 Storage unit
13 Control unit
121 Operation log
122 Difficulty level data
131 Collection unit
132 Proficiency element extraction unit
133 Difficulty level acquisition unit
134 Proficiency level calculation unit

1. A processing method comprising:
a step of collecting operation logs of terminals used by a plurality of staffs who perform work;
a step of extracting a feature amount for each staff from the collected operation logs; and
a step of calculating a proficiency level of work for each staff from the feature amount extracted for each staff, wherein
the calculating the proficiency level further comprises performing first weighting value that increases as time required for work increases or second weighting value that increases as an error rate, and the error rate represents a ratio of the number of times of use of a backspace/delete key to the total number of key inputs increases on the basis of work performed by the staff when the operation log is collected.

2. The processing method according to claim 1, wherein
the feature amount includes a plurality of types,
the feature amount includes the number of times of use of an alt key on a keyboard of the terminal, the number of times of use of a mouse connected to the terminal, and the number of times of a paste operation among operations in the terminal, which are acquired from the operation log, and
the calculating step further comprises calculating the proficiency level for each staff on the basis of a first relationship in which the proficiency level increases as the number of times of use of the alt key increases, a second relationship in which the proficiency level increases as the number of times of use of the mouse decreases, and a third relationship in which the proficiency level increases as the number of times of the paste operation decreases.

3. The processing method according to claim 1, wherein the collecting step further comprises acquiring, as the operation logs, an input form displayed on a screen of the terminal and a direct ancestor of the input form in a user interface tree.

4. The processing method according to claim 1, wherein
the feature amount includes a plurality of types, and
the calculating step further comprises calculating a feature amount of a type corresponding to a work environment of the staff is selected from the feature amount, and the proficiency level for each staff on the basis of the feature amount of the selected type.

5. The processing method according to claim 1, wherein the calculating step further comprises calculating the proficiency level for each staff using a model, and the model is trained based on a relationship between a feature amount of a type according to a work environment and a proficiency level for each work environment of the staff.

6. The processing method according to claim 1, wherein the first weighting value indicates a value obtained, on the basis of a plurality of operation logs of a plurality of staffs, at a predetermined timing for each work environment of the staff.

7. A processing device comprising a processor configured to execute operations comprising:
collecting operation logs of terminals used by a plurality of staffs who perform work;
extracting a feature amount for each staff from at least a part of the collected operation logs; and
calculating a proficiency level of work for each staff from the extracted feature amount for each staff, wherein
the calculating further comprises performing first weighting value that increases as time required for work increases or second weighting value that increases as an error rate increases on the basis of work performed by the staff when the operation log is collected.

8. A computer-readable non-transitory recording medium storing computer-executable program instructions that when executed by a processor cause a computer to execute operations comprising:
collecting operation logs of terminals used by a plurality of staffs who perform work;
extracting a feature amount for each staff from the collected operation logs; and
calculating a proficiency level of work for each staff from the feature amount extracted for each staff, wherein
the calculating further comprises performing first weighting value that increases as time required for work increases or second weighting value that increases as an error rate increases on the basis of work performed by the staff when the operation log is collected.

9. The processing method according to claim 1, further comprising:
a step of transmitting the calculated proficiency level of work for a staff through a network to an application configured to display the calculated proficiency level.

10. The processing method according to claim 2, wherein the collecting step further comprises acquiring, as the operation logs, an input form displayed on a screen of the terminal and a direct ancestor of the input form in a user interface tree.

11. The processing device according to claim 7, the processor further configured to execute operations comprising:
transmitting the calculated proficiency level of work for a staff through a network to an application configured to display the calculated proficiency level.

12. The processing device according to claim 7, wherein
the feature amount includes a plurality of types,
the feature amount includes the number of times of use of an alt key on a keyboard of the terminal, the number of times of use of a mouse connected to the terminal, and the number of times of a paste operation among operations in the terminal, which are acquired from the operation log, and
the calculating further comprises calculating the proficiency level for each staff on the basis of a first relationship in which the proficiency level increases as the number of times of use of the alt key increases, a second relationship in which the proficiency level increases as the number of times of use of the mouse decreases, and a third relationship in which the proficiency level increases as the number of times of the paste operation decreases.

13. The processing device according to claim 7, wherein the collecting further comprises acquiring, as the operation logs, an input form displayed on a screen of the terminal and a direct ancestor of the input form in a user interface tree.

14. The processing device according to claim 7, wherein
the feature amount includes a plurality of types, and
the calculating further comprises calculating a feature amount of a type corresponding to a work environment of the staff is selected from the feature amount, and the proficiency level for each staff on the basis of the feature amount of the selected type.

15. The processing device according to claim 7, wherein the calculating further comprises calculating the proficiency level for each staff using a model, and the model is trained based on a relationship between a feature amount of a type according to a work environment and a proficiency level for each work environment of the staff.

16. The computer-readable non-transitory recording medium according to claim 8, the computer-executable program instructions when executed further causing the computer system to execute operations comprising:
transmitting the calculated proficiency level of work for a staff through a network to an application configured to display the calculated proficiency level.

17. The computer-readable non-transitory recording medium according to claim 8,
the feature amount includes a plurality of types,
the feature amount includes the number of times of use of an alt key on a keyboard of the terminal, the number of times of use of a mouse connected to the terminal, and the number of times of a paste operation among operations in the terminal, which are acquired from the operation log, and
the calculating further comprises calculating the proficiency level for each staff on the basis of a first relationship in which the proficiency level increases as the number of times of use of the alt key increases, a second relationship in which the proficiency level increases as the number of times of use of the mouse decreases, and a third relationship in which the proficiency level increases as the number of times of the paste operation decreases.

18. The computer-readable non-transitory recording medium according to claim 8,
wherein the collecting further comprises acquiring, as the operation logs, an input form displayed on a screen of the terminal and a direct ancestor of the input form in a user interface tree.

19. The computer-readable non-transitory recording medium according to claim 8, wherein
the feature amount includes a plurality of types, and
the calculating further comprises calculating a feature amount of a type corresponding to a work environment of the staff is selected from the feature amount, and the proficiency level for each staff on the basis of the feature amount of the selected type.

20. The computer-readable non-transitory recording medium according to claim 8,
wherein the calculating further comprises calculating the proficiency level for each staff using a model, and the model is trained based on a relationship between a feature amount of a type according to a work environment and a proficiency level for each work environment of the staff.
